(19) United States
(12) Patent Application Publication
(10) Pub. No.: US 2023/0298781 A1
(43) Pub. Date: Sep. 21, 2023

(54) STRANDED WIRE WITH GOOD ELECTRICAL INSULATION

(71) Applicant: SUNG IN HONG, Datian City (KR)

(72) Inventor: SUNG IN HONG, Datian City (KR)

(21) Appl. No.: 17/983,790

(22) Filed: Nov. 9, 2022

Related U.S. Application Data
(63) Continuation-in-part of application No. PCT/CN2022/129342, filed on Nov. 2, 2022.

(30) Foreign Application Priority Data
Mar. 19, 2022 (CN) 202220602228.8

(51) Int. Cl. H01B 7/00; H01B 1/02

(52) U.S. Cl. CPC H01B 7/00; H01B 1/02

(57) ABSTRACT

A stranded wire with good electrical insulation, including a plurality of first copper conductors and a plurality of second copper conductors, wherein each of the plurality of first copper conductors is coated with a first insulating layer, a first self-bonding layer, from inside to outside; each of the plurality of second, copper conductors is coated with a second insulating layer. and a heat shrinkable insulating sleeve is provided around a stranded wire body composed of the plurality of first copper conductors and the plurality of second copper conductors; and the heat shrinkable insulating sleeve is provided with a third insulating layer, a second self-bonding layer, in sequence from inside to outside.

### TECHNICAL FIELD

The present application relates to the technical field of wires and cables, and more particularly to a stranded wire with good electrical insulation.

### BACKGROUND

An enameled wire is a main kind of winding wires, which is mainly composed of a conductor and an insulating layer. A bare wire is annealed to increase its ductility, and then varnished and baked many times to obtain the enameled wire. However, it is not easy to produce products that meet both standard requirements and customer requirements. Affected by raw material quality, process parameters, production equipment, environment and other factors, quality characteristics of various enameled wires are different, but they all have properties in four major aspects: mechanical properties, chemical properties, electrical properties and thermal properties.

At present, enameled wires are mainly produced in the following three manners.

In a first manner, individual enameled wires are each coated with a self-bonding layer and then are stranded, which has the following disadvantages:
1. poor pinholes exist; and
2. the self-bonding layer is thin and bonding strength between stranded wires is low.

In a second manner, a self-bonding filament is wound around an enameled stranded wire, which has the following disadvantages:
1. poor pinholes exist;
2. the thickness of the self-bonding filament is thick and cannot be easily adjusted, resulting in a relatively large diameter of the whole stranded wire;
3. the surface of the self-bonding filament is not smooth and product appearance is of poor quality;
4. the self-bonding filament is difficult to melt, leading to difficult tin soldering and a lot of residues; and
5. production costs of coating the stranded wire with the self-bonding filament are high.

In a third manner, an enameled stranded wire, as a whole, is coated with a self-bonding layer, which has the following disadvantages:
1. poor pinholes exist; and
2. costs of coating the stranded wire with the self-bonding layer are high.

### SUMMARY

In view of the above-mentioned deficiencies in the related art, an objective of the present application is to provide a stranded wire with good electrical insulation, which has the advantages of good electrical insulation, a high, yield and a long service life.

The technical objective of the present application is achieved via the following technical scheme: a stranded wire with good electrical insulation, including: a plurality of first copper conductors and a plurality of second copper conductors, wherein each of the plurality of first copper conductors is coated with a first insulating layer, a first self-bonding layer from inside to outside; each of the plurality of second copper conductors is coated with a second insulating layer and a heat shrinkable insulating sleeve is provided around a stranded wire body composed of the plurality of first copper conductors and the plurality of second copper conductors; and the heat shrinkable insulating sleeve is provided with a third insulating layer, a second self-bonding layer in sequence from inside to outside.

To sum up, the beneficial effects of the present application are as follows:
1. The adjacent copper conductors, that is, the plurality of first copper conductors and the plurality of second copper conductors are twisted together to form the stranded wire body. As each of the first copper conductors and each of the second copper conductors are respectively coated with the first insulating layer and the second insulating layer, an internal insulation property of the stranded wire body is improved by the arrangement of the first insulating layer and the second insulating layer. The plurality of first copper conductors and the plurality of second copper conductors are tightly adhered together by using the first self-bonding layers, thereby reducing the diameter of the stranded wire body and avoiding redundancy of internal space of the stranded wire body.
2. The heat shrinkable insulating sleeve is provided around the stranded wire body. Part of the first copper conductors and part of the second copper conductors can be effectively adhered by the first self-bonding layers arranged in a heat shrinkable insulating layer, thereby realizing bonding and fixation of the copper conductors in the stranded wire body. The third insulating layer is for further insulating treatment.

### BRIEF DESCRIPTION OF DRAWINGS

FIG. 1 is a cross-sectional view of an embodiment of the present application.

List of reference numerals: 1. first copper conductor; 1-1. first insulating layer; 1-2. first self-bonding layer.; 2. second copper conductor; 2-1. second insulating layer. 3. heat shrinkable insulating sleeve; 3-1. third insulating layer; 3-2. second self-bonding layer.

### DETAILED DESCRIPTION

In order to make the technical problems to be solved by the present application and technical schemes and beneficial effects of the present application more apparent, the present application is further described in detail in conjunction with the accompanying drawings and embodiments. It should be understood that the particular embodiments described herein are only intended to explain the present application, and are not intended to limit the present application.

It should be noted that one component, when said to be “fixed to” or “provided on” the other component, may be directly or indirectly situated on the other component, and one component, when said to be “connected to” the other component, may be directly or indirectly connected to the other component.

It should be understood that, orientation or positional relationships indicated by terms such as “length”, “width”, p″, “down”, “front”, “back”, “left”, “right”, “vertical”, “horizontal”, “top”, “bottom”, “inside”, and “outside” are based on the orientation or positional relationships shown in the accompanying drawings, and are to facilitate the description of the present application and simplify the description only, rather than indicating or implying that the device or element referred to must have a specific orientation or be constructed and operated in a specific orientation, and therefore cannot be construed as limiting the present application.

In addition, the terms “first” and “second” are for the purpose of description only and should not be construed as indicating or implying relative importance or implicitly indicating the number of technical features indicated. Thus, features defined with “first” and “second” may include one or more of the features either explicitly or implicitly. In the description of the present application, the term “plurality” means two or more, unless otherwise explicitly and specifically defined.

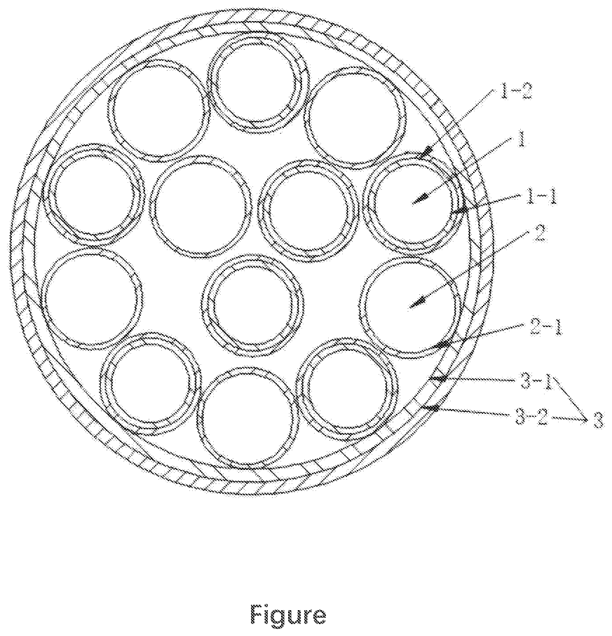

A stranded wire with good electrical insulation, as shown in FIG. 1, includes: a plurality of first copper conductors 1 and a plurality of second copper conductors 2, wherein each of the plurality of first copper conductors 1 is coated with a first insulating layer 1-1, a first self-bonding layer 1-2 from inside to outside; each of the plurality of second copper conductors 2 is coated with a second insulating layer 2-1; and a heat shrinkable insulating sleeve 3 is provided around a stranded wire body composed of the plurality of first copper conductors 1 and the plurality of second copper conductors 2; and the heat shrinkable insulating sleeve 3 is provided with a third insulating layer 3-1, a second self-bonding layer 3-2 in sequence from inside to outside.

In this embodiment, the adjacent copper conductors, that is, the plurality of first copper conductors 1 sand the plurality of second copper conductors 2 are twisted together to form the stranded wire body. As each of the first copper conductors 1 and each of the second copper conductors 2 are respectively coated with the first insulating layer 1-1 and the second insulating layer 2-1, an internal insulation property of the stranded wire body is improved by the arrangement of the first insulating layer 1-1 and the second insulating layer 2-1. The first lubricating layer 1-3 and the second lubricating layer 2-2 facilitate improvement of mobility between the first copper conductor 1 and the second copper conductor 2 before fixing. The plurality of first copper conductors 1 and the plurality of second copper conductors 2 are tightly adhered together by using the first self-bonding layers 1-2, thereby reducing the diameter of the stranded wire body and avoiding redundancy of internal space of the stranded wire body.

The heat shrinkable insulating sleeve 3 is provided around the stranded wire body. A part of the first, copper conductors 1 and a part of the second copper conductors 2 can be effectively adhered by the first self-bonding layers 1-2 arranged in a heat shrinkable insulating layer, thereby realizing bonding and fixation of the copper conductors in the stranded wire body. The heat shrinkable insulating layer can improve poor pinholes, and the third insulating layer 3-1 is for further insulating treatment.

Specifically, the first insulating layer 1-1, the second insulating layer 2-1 and the third insulating layer 3-1 are all sleeves made of a heat shrinkable material which can shrink when subjected to heat during production, is harmless to the environment and human bodies, and further reduces the diameter of the stranded wire body and the diameter of the first copper conductors 1, thereby ensuring that the stranded wire has certain hardness and also toughness.

The improved stranded wire with the good electrical insulation in this embodiment is also called a self-bonding enameled multi-stranded copper wire, and also called as Hi-Q Self Bonding Wire. The stranded wire has a multi-layer insulation mechanism. For a traditional UEW wire, corresponding experimental reference is made:

| No. | Test item | Hi-Q Self Bonding Wire | | UEW Wire |
|---|---|---|---|---|
| 1 | Poor pinholes | Not Found | | Found |
| 2 | Insulation and | In water | 1000 | 0 |
| | voltage resistance | In air | 1300 | 400-700 |
| | (V) | | | |
| 3 | Corrosion | Excellent | | Poor |
| | resistance | | | |
| 4 | Wear resistance | Excellent | | Poor |
| 5 | Terminal | Excellent | | Good |
| | positioning | | | |
| 6 | Radio noise | Good | | Average |
| | intensity | | | |

The above-mentioned embodiment is only an explanation of the present application, and is not a limitation of the present application. After reading this specification, those skilled in the art can make modifications to this embodiment as required without creative effort, but the modifications are protected by the patent law as long as they are within the scope of the claims of the present application.

1. A stranded wire with good electrical insulation, comprising: a plurality of first copper conductors and a plurality of second copper conductors, wherein
each of the plurality of first copper conductors is coated with a first insulating layer, a first self-bonding layer from inside to outside;
each of the plurality of second copper conductors is coated with a second insulating layer;
a heat shrinkable insulating sleeve is provided around a stranded wire body composed of the plurality of first copper conductors and the plurality of second copper conductors; and the heat shrinkable insulating sleeve is provided with a third insulating layer, a second self-bonding layer in sequence from inside to outside.
